(19) United States
(12) Patent Application Publication
(10) Pub. No.: US 2004/0205132 A1
(43) Pub. Date: Oct. 14, 2004

(54) Assignment of screen space for input of information by multiple independent users from different locations simultaneously

(76) Inventor: Larry R. Czerwonka, Ridgecrest, CA (US)

Correspondence Address: Bruce A. Jagger, 6100 Center Drive, Los Angeles, CA, 90045, US

(21) Appl. No.: 10/776,798

(22) Filed: Feb. 11, 2004

Related U.S. Application Data
(62) Division of application No. 09/684,311, filed on Oct. 6, 2000.
(60) Provisional application No. 60/158,405, filed on Oct. 7, 1999.

(51) Int. Cl. G06F 15/16

(52) U.S. Cl. 709/205

(57) ABSTRACT

The present invention provides a system and methodology for allowing multiple parties in different locations to create and maintain a grouping of related files and information and make the information available to end-users over the Internet. The system breaks each web page into regions or screen space areas and then assigns exclusive access rights to each region. A single page may be made up of one or two to a multiple of regions. Each region is controlled by a different content provider and is created, updated and maintained separately from the rest of the data holding regions on the page. Information that appears in one region may appear on other regions on other pages, thus allowing the controller of the screen space to make a single update and have the update appear throughout the site or sites. Through the assignment of regions, it is impossible for one user to overwrite another user's data that is located in a different screen space area. The assignment of individual regions to advertisers gives them the ability to directly update their ads without having to go through a web master or anyone else.

### RELATED APPLICATION

This application is a divisional application of Ser. No. 09/684,311, filed Oct. 6, 2000, which is claims the benefit of Provisional Patent Application Serial No. 60/158,405 filed Oct. 7, 1999.

### BACKGROUND OF THE INVENTION

1. Field of the Invention

The present invention relates in general to novel decentralized systems and methods for collecting web site content from a plurality of independent sources and placing such content on web sites. More particularly, the present invention relates to a novel system and method for assigning different portions of a web site to different content providers, and permitting each content provider to create and modify its portion of the web site without interaction with or interference from the other content providers or a web master. The present invention further permits a single web page to be divided into several separate portions with each separate portion being assigned exclusively to and controlled independently by a different content provider.

2. Description of the Prior Art

For centuries, various types of media have been used to realize such fundamental business functions as keeping customers informed concerning the goods and services offered by a business. Recently, there have been a number of fundamental changes in the way information may be communicated. The global information network called the “internet”, provides a new way for businesses to communicate with their customers. Many companies have created multimedia Internet web sites in order to advertise, sell and maintain their products and services. Many such web sites include a large number of individual web pages. Each page or portion of a page can present some unique content to those who visit the web site. Examples of the developments that have made possible the creation and use of web sites include, for example, the World Wide Web (WWW) based in the Hypertext Markup Language (HTML) and the Hypertext Transmission Protocol (HTTP). Easy to use graphical user interfaces (GUI) based Internet navigation tools and browsers have placed access to the internet within the reach of many millions of people worldwide. Such recent developments have made it very easy and desirable for businesses to create Hypermedia-based web sites for the purpose of, for example, projecting a desired “corporate image”, providing a backdrop for financial investment solicitation, product and service advertising, sales, operation and maintenance. However, difficulties have been experienced in maintaining the currency and accuracy of the information on such web sites. This is particularly true for large organizations where control of the web site is vested in one individual, generally called a “web master”.

Presently, a person in an organization who desires to update something as simple as a meeting date on an organization's web site must generally send the date change to the web master, and wait for the web master to find the time to update the web site. The person must then check the web site online to make sure that the web master entered the correct meeting date. In larger organizations, the posting of the information may go through several web masters before it actually goes on line. If the operator of the web site does allow the person to directly change the date, there is a risk that the entire web site may be damaged. The danger with allowing direct access to change the web site is that in order to update just the one meeting date with the tools that are presently available, the entire page must be updated. This could result in overwriting something someone else was working on at the same time, or damaging the entire page if not the whole web site.

Previous “site management systems” have simply provided a tool for updating an entire web page. Thus, such previous expedients have failed to adequately address the information collection and dissemination needs of most web site operators. Previous expedients generally operated in a hierarchical manner with a bottle neck in the information flow cycle, disabling information providers from communicating with the end users in an efficient timely manner to satisfy the needs of both the end user and the information provider.

Dissemination of information over the internet must be accurate and timely. The traditional methods of collecting information for web site content from multiple sources through phone calls, faxes and email are time consuming and resource intensive. In general, corporations, government agencies and other entities have attempted to collect and disseminate large volumes of information by funneling the information through a few web masters, who actually control putting the information on a web site. This process is too labor intensive and often results in data being posted after it is of any importance.

The effect of centralized control over all of the information on a web site is to create a bottleneck in the process, which can only be handled by involving more and more people in exercising centralized control. But even using more people at the location of centralized control does not solve the problem. When all of the data permitted on a web page or a web site comes from one source, generally one large database, and only one person, the web master, has the right to clear information for posting on the web site, delay and inaccuracy are inevitable.

While the above-described information systems attempt to collectively cooperate to optimize the process of moving information into the hands of the consumer, such centralized information systems fail to address the need for information to be timely and cost effective. Presently, web site operators are expending an enormous amount of time, money and effort in order to maintain current information on their respective web sites.

For example, one user may wish to place a new story on the opening page of an organization's web site. If there are two other people wishing to make changes to the same opening page they will have to wait until the first person has finished, or they might write over the changes that the first person just made.

The problem of writing over what someone else has just changed is why most organizations only allow a handful of people to actually update a web site, and why they generally make sure that these people are all located in the same building.

When the editors cannot be located in the same building, changes are generally sent to a central location for approval before being posted on the web site. This central processing house is responsible for ensuring that people are not writing over someone's work.

These control points generally become the bottlenecks that make updating a web site a slow process. Where there may be fifty people submitting changes to the site, and fifteen people actually changing the HTML code, it then goes to one or two people who must ensure that it all fits together before putting it on-line on the web site.

Thus, it is clear that there is a great need in the art for improvements in collecting, transmitting, and delivering information for posting on web sites. These and other disadvantages of the prior art have been overcome according to the present invention by decentralizing and compartmentalizing the posting of content to web pages in a web site.

It is very common practice in the art for programmers to divide each of the pages in a web site into discrete areas so that different content can be placed in those different areas. For example, banner advertisements are typically displayed on a page in a predefined area. Typically, although there may discrete areas defined on a page with specific assigned content, the entire page remains under the control of a central authority.

Various software tools are now conventionally available to enable a person who is not capable of writing programming code to create and amend the content of a web page. Within the limitations of the commercially available programming software tools, individuals who are not literate in any programming language can create and modify the content of web pages.

### BRIEF SUMMARY OF THE INVENTION

A preferred embodiment of the method according to the present invention comprises dividing a web site, usually at the web page level, into at least two discrete areas, isolating the control of the respective areas from one another, and assigning control over each area to a different controlling authority. Control of the content on the web pages is thus decentralized and placed directly in the control of those who provide the content. The control of any specific area on a web site can preferably be exercised by an individual from any location in the world where there is access to a networking setup such as, for example, the internet. Control over the content of the discrete area can be exercised whether the individual is capable of creating programming code or not. Control of an area is conveniently restricted to those authorized to exercise that control by means of passwords and the like. There is great flexibility in the granting of control over various areas. If desired, one individual can, for example, be granted control over the content on one or more entire pages within a web site, or over portions of different pages on the same or different web sites.

A primary object of the present invention is to provide a novel method and apparatus for collecting information and transmitting and delivering the same between the information provider and the end users at home, at work and on the road, while overcoming the shortcomings and drawbacks of prior art system and methodologies.

Currently services exist to enable individuals to create and update a web site with no knowledge of HTML programming language. These tools include commercially available software packages as such as, for example, Microsoft Front Page by Microsoft, Netscape Communicator by Netscape, and the Like higher end software. Although all of these software packages presently allow for the creation and updating of a web page, people making changes, in order to keep from writing over each others work, must still coordinate their efforts with others who may also be making changes to the same web page.

An object of the present invention is to provide an easy to use input system, which allows information providers to quickly update their screen space or multiple screen spaces on a web site or sites without effecting the surrounding screen space or having to coordinate their efforts with others.

Another object of the present invention is to provide a system, which allows multiple parties to contribute to and maintain a web site without funneling their information through a central point.

Another object of the present invention is to permit a change made by one person to ripple through all of the screen spaces that are controlled by that person, whether all such spaces are on one single, or multiple web sites. That is, the screen spaces on various separate pages are linked so that any change to one screen space appears immediately on all of the linked screen spaces on various pages, wherever they may be found. The present invention allows an entity to have duplicate screen space on many different pages of a web site or many different web sites. This means that information entered in one screen space will also appear on other pages within the same web site or on other web sites entirely. The individual making the change just does it in one place but since all of the screen spaces are linked, the change automatically appears in all of the other screen spaces. A business, for example, can change the price listed in an advertisement that appears on hundreds of different web sites with one single entry, and have that price change appear immediately on all of the web sites. Advertisements and other content can thus be changed to immediately accommodate changed circumstances. Thus, an advertisement can be changed on hundreds of web sites within seconds after an athletic event is concluded so as to take immediate advantage of the outcome of the event.

The present invention takes away the need for coordination between individuals and allows them to make changes to their piece of the screen without affecting anything else on the page.

According to the present invention, discrete separate screen spaces within a web page can also be sold, leased, rented or auctioned to the highest bidder. Thus, instead of just telling an advertiser or content contributor that its banner will appear at the top of a web page, the web site owner can give the content contributor access to and control of the screen space at the top of the screen. The contributor can then change the content as often as may be desired without having to interface with the web site owner or the other content providers. This access and control can be as liberal or controlled as the web site owner wishes and can be turned on and off. The screen space can be let by the minute, hour, day, week, month or any other time frame that the web site owner sees fit to permit.

The present invention allows a web site owner to divide and assign screen space as it sees fit, to monetize these assignments, and to run a vibrant web site with lots of content coming in from a variety of places. The web site owner is not paying for the content, in fact, the owner is getting paid for allowing access to the site and the site's audience.

The material that appears in the discrete screen space can be anything that can be displayed through a web browser, including, for example, text, graphics, audio, video, animation, software download, and the like. The contributors can place articles into their screen space, or a video, or an advertisement, or the like. Since the space is, for example, just a piece of an HTML document, any HTML compliant data may be placed in it. Various other programming languages can be used, if desired.

According to the present invention a novel environment is provided in which the updating and maintenance of a web site becomes cost effective due to the ease with which regions of the site are updated. The site is always up to date and filled with current information. The present invention allows an entire company to become “web masters” and thus the web site has, for example, 50 people working on it instead of one or two.

A system and methodology are presented for allowing multiple parties in different locations to create and maintain a grouping of related files and information and to make the information available to end users over the internet. The system breaks each web page into regions or screen space and then assigns access rights to each region. A single page may be made up of one or two to a handful of regions. Each region is controlled by a different party and is updated separately from the rest of the data on the page. Information which appears in one region may also appear on other regions on other pages, thus allowing the owner of the screen space to make a single update and have it appear throughout the site. Through the assignment of regions, it is impossible for one user to overwrite another user's data. Regions can also be assigned to advertisers giving them the ability to update their ad without having to go through a web master. These advertisers have access only to their regions and therefore the site owner does not have to worry about other areas on the site being changed by the advertisers or any other information provider for that matter. Regions of a web page are assigned to different content providers. The different content providers are allowed to collectively create and update their regions without interaction with the other content providers. The end result is a single web page filled from information from many sources.

### BRIEF DESCRIPTION OF THE DRAWINGS

The present invention provides its benefits across a broad spectrum of web site activity. While the description which follows hereinafter is meant to be representative of a number of applications, it is not exhaustive. As those skilled in the art will recognize, the basic systems taught herein can be readily adapted to many uses. It is Applicant's intent that this specification and the claims appended hereto be accorded a breadth in keeping with the scope and spirit of the invention being disclosed despite what might appear to be limiting language imposed by the requirements of referring to the specific examples disclosed.

Referring particularly to the drawings for purposes of illustration only, and not limitation:

FIG. 1 is a diagramatic screen shot illustrating portions of a web page assigned to the control of different content providers.

FIG. 2 is a diagramitic screen shot showing an interface form by means of which a content provider can create and change the content of a portion of a web page that is under that content provider's control.

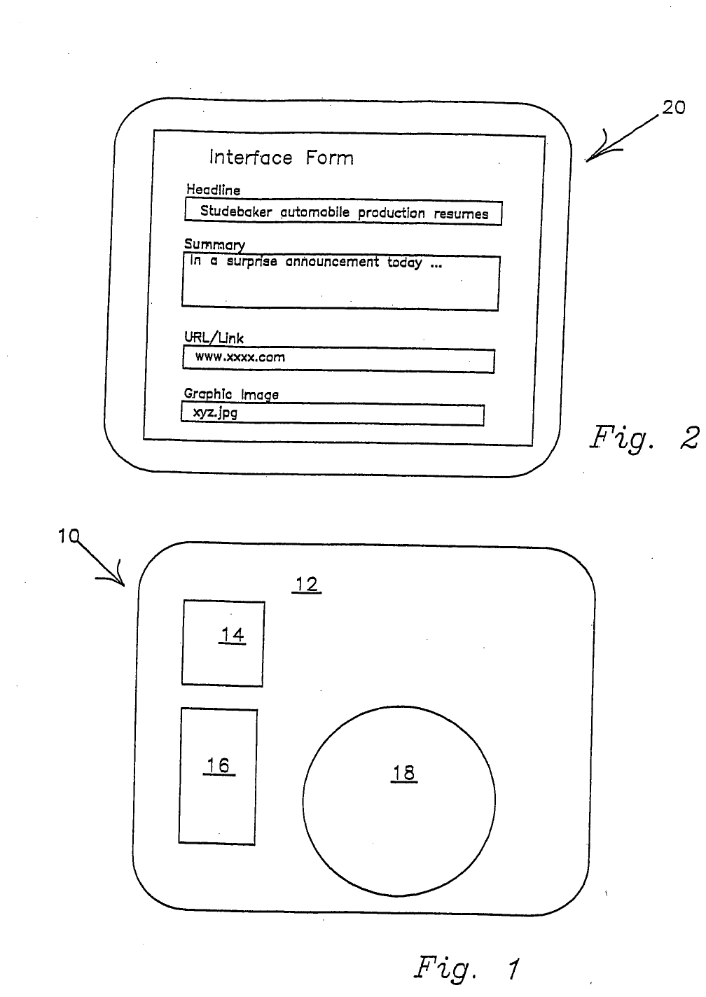

### DETAILED DESCRIPTION OF THE PREFERRED EMBODIMENTS

The present invention allows an operator of a web site to assign access rights not just to pages within the site but to areas (“screen space”) within each page itself. Referring particularly to the drawings for the purposes of illustration only there is illustrated generally at 10 a web page 12 displayed on a users computer monitor. The web page is generally, although not necessarily, one of a number of web pages that taken together make up a web site.

The web page 12 has three areas divided off by visible boundary markers. The boundary markers can be lines, colors, changes in texture, or any other detectable marker. In general the boundaries are defined by visually detectable markings for display with conventional computer monitors, but audible or tactile boundaries or the like can be provided for special display devices, if desired. All aspects of the appearance of the respective boundaries can be varied on a single page so as to emphasize the distinctions between them.

The respective boundaries on web page 12 enclose discrete areas or screen spaces 14, 16 and 18 of the web page. The upper right hand quadrant of the web page 12 has not been marked off with any boundary so it is available for future use. Each of the discrete areas 14, 16, and 18 occupies a portion of the web page and is under the control of a separate entity. The control of the content in these separate areas is thus decentralized from the control of the owner of the web site. The underlying web page 12 is under the control of the web site owner, who can, if necessary, selectively override the control that is exercised by any one or all of the respective separate entities.

The screen space area that is controlled by a particular content provider is made available to the content provider for changes by means of an interface form. A web page is illustrated generally at 20. One preferred form of an interface form is illustrated on web page 20. The illustrated interface form is supported by pre-programming by the web site owner so that the content provider does not need to write any programming code to enter the desired content on the screen space area that is controlled by that content provider.

The interface form is prepared by the web site owner and provided to the content provider. When the content provider desires to put content on the screen space that is assigned to it, it loads the interface form so that the form is displayed on the content provider's monitor. When the content has been entered by the content provider into the interface form, it is transmitted in digital form to a data table that is associated the web site or sites where the content is to appear. There may be one or more data tables for each web site or one or more web sites for each data table. Also, automatically transmitted with the content is a unique content identifier that goes with the transmitted content into the data table. The data table can be in any form. It is simply a structured collection of digitally recorded data that can be modified by the content providers and pulled to the respective screen space areas.

A piece of programming code called an “include file” is associated with each screen space area on a web site. Include files are generally known to those skilled in the art. The purpose of an include file is to continually search a data table for information to bring to the web page with which the include file is associated. Include files on the individual web pages in the web site continually query the data table. Each include file is continually looking through the data table for content that is associated with the one unique content identifier which that include file is programmed to recognize. When an include file finds content in the data table that is associated with the particular content identifier that the include file is looking for, it brings that content to the web page with which it is associated. There is an include file for each separate screen space area. According to the present invention, when a particular include file finds its unique content identifier and pulls content from the data table, that content is processed at the web page and placed in the screen space area with which the particular include file is associated, and no where else on the page.

The content is generally, although not necessarily, stored in plain ascii form in the data table. This standardization permits different web sites to use the same data table. Various web pages on the same or different web sites can have include files that continually query the same or multiple data tables for the same unique content identifier. When transmitted by the content provider, the content ripples from the data table through the web pages in the various web sites where associated include files appear. The content thus appears immediately on all of the associated screen space areas, wherever they may be.

To the content provider it appears that the content moves almost instantaneously from the interface form to all of the involved web pages. Other than the initial set up of the screen space area and the interface form, the web site owner is not involved in posting the content. Great flexibility can be provided in that regard. If for some reason the web site owner is required to be involved, that can be provided for in the set up phase. For example, if peer review of scientific studies is required as a pre-condition to publication on a web page devoted to such studies, such a review can be provided for an initial publication. Thereafter, exchanges of commentary concerning that publication can be posted to the applicable web pages without delay or interaction with the web site owner.

Various interface forms can be provided by the web site owner for the convenience and needs of the content providers. A preferred form is one where the content provider does not have to write programming code to get the content onto the screen space area. Some content providers, however, need the flexibility that programming provides, so they require interface forms where the content can be supplied in the form of programmed code, usually HTML. Each screen space area can have one or more interface forms associated with it, but preferably only one such form is provided so as avoid confusion at the location of the content provider. The interface form preferably informs the content provider what the current content of the screens space area is so that accurate amendments can be made without the need to recreate the entire content to make one small change.

In setting up the system, the web site owner and the content provider decide where on a page within a web site a particular screen space area is to be placed. The web site owner provides program code that defines the location and format of that particular screen space area. An include file for that area is provided in the code for the page. The specific include file is programmed to look in an associated data table for a specific unique content identifier. The web site owner performs the programming to create an interface form for the specific screen space area. The interface form is programmed to always transmit the unique content identifier to the web site whenever content is transmitted by the content provider. The unique content identifier is a piece of programming code that enables the content provided on a particular interface form to be associated with a particular area on a web page. The unique content identifier and include file are defined by the same program coding that is conventionally used to identify an area of a web page for the placement, for example, of a banner ad by a web owner.

The interface form is defined by the same type of program coding that is conventionally used by web site owners to enter content into a web site. Some commercially available software programs are also capable of performing the necessary content creation and transmission. In general, the content is transmitted from the interface form at the content provider's site to a display table at the web owner's site. There the display table is modified to provide the desired content on the screen space area, and the change in the display table is immediately reflected in the screen space area where visitors to the web site may see it. The use of display tables in connection with presenting content on web pages is conventional.

The programming of the display table follows conventional protocols for such display tables. The owner of the web site generally provides the basic framework of the programmed code for the display table. Code is preferably tailored for each screen space to fit the needs of the content provider for that screen space. If the owner of the web site desires to exercise certain controls over the content, such controls are conveniently exercised through the programming of the data table. For example, the web site owner may have a web site wide policy against the use of certain words on its web site. A filter can be programmed into the display table that will not allow such words to appear in any content on the web site.

Each content provider is given exclusive (except for the web site owner) access to a screen space area. Generally, such access is controlled by means of a user identification and a user password, generally described as “content provider identification”.

Screen space can be defined for every inch of a web site on every page that makes up the site or just on a few pre-determined pages. Where screen space is assigned and how it is used is up to the web site owner. The owner then assigns each screen space module to, for example, a “renter.” A renter can be anyone from an employee of the web site owner, to another business, to an individual, or a government agency. Anyone with access to the content management device (such as a computer) where the site administration software (interface form) is located, and the content provider identifier, can use the system. The interface form can be located anywhere so long as it can be accessed by the content provider. It need no reside on the content provider's local machine.

The web site owner determines the size and location for each screen space and a rental fee (if any) as well as the length of the rental period. The rental period can be any amount of time from minutes to months to even years.

The renters screen space may only appear on a single web page and be limited to the height and width defined by the site owner or it may be limited in size on one page but may have a link to another page within the site where the story or advertisement is expanded upon. This link could also be to another web site, which may or may not be owned by the person granting the original screen space. The link could also be to a popup window, which overlays on top of the renter's screen space.

All of the conventional transactional tools can be employed for electronic commerce purposes with the distributed content control systems of the present invention. Such tools include, for example, security and payment systems.

The distributed content control system of the present invention permits a web site hosting business to operate with many customers and a minimal staff. The staffing requirements are determined primarily by the set up load. The staff that is required can be distributed all over the world, if desired. Each customer can control his portion of the web site without interference with or assistance from the web host or the other users.

Communication management is facilitated by the present invention. Numerous individual sources of data, such as people or sensors, can be permitted to supply data to predetermined regions on a large web site without risk of interfering with the collection of data from other sources. The data can be retrieved (continuously or batchwise) from the several different regions, aggregated by some site wide collection program, and analyzed to provide meaningful real time information upon which policy and management decisions can be made. The term “web site” as used herein and in the claims hereto is intended to include all systems that are capable of handling distributed content input as described herein. Thus, a military unit such as an aircraft carrier with electronically integrated command and control systems is a web site as defined herein. In this example the web owner would be the Captain of the ship.

It should also be understood that there could be many other variations, modifications and adaptations which are apparent to those skilled in the art which fall within the spirit and scope of the invention as disclosed herein which is meant to be but one embodiment of the invention defined by the claims and their legal equivalents.

1-3 (canceled)

4: A method of distributed screen space content control comprising:
establishing independent updateable screen space areas on a web site that is operated by a web site owner and includes a plurality of web pages;
establishing a unique location for each said screen space area on a web page, and establishing a format for said content that may be entered into each said screen space area, and providing program code associated with each said screen space area that is capable of identifying a unique content identifier;
identifying a plurality of independent content providers and assigning a said unique content identifier to each such content provider;
allowing each said content provider to submit content associated with its unique content identifier to said web site, and allowing said program code to recognize the unique content identifier that was assigned to a said content provider and to pull said content to the screen space area that such program code is associated with; and
displaying the content submitted by said content provider in the screen space area that said content was pulled to.

5: A system for collecting information for display on the internet comprising:
collecting information from a provider of such information;
relating such information to a particular region on a computer screen;
storing such information;
controlling which region of said computer screen said information is displayed in; and
controlling access to the region of said computer screen where said information is stored.

6: A system for collecting information for display on the internet according to claim 5 including providing said provider with a form for inputting said information.

7. (canceled)
